(19) United States
(12) Patent Application Publication
(10) Pub. No.: US 2024/0169817 A1
(43) Pub. Date: May 23, 2024

(54) PROXIMITY SENSING METHOD AND APPARATUS

(71) Applicant: EATON INTELLIGENT POWER LIMITED, Dublin, 4 (IE)

(72) Inventors: Padhraig RYAN, Keatingstown (IE); Daniel ZUCCHETTO, Dublin (IE); Keith NOLAN, Westmeath (IE); Neil BROCKETT, Ballybunion (IE); Julia O'CONNELL, Ballsbridge (IE)

(21) Appl. No.: 18/552,123

(22) PCT Filed: Mar. 29, 2021
(86) PCT No.: PCT/EP2021/058166

§ 371 Date: Sep. 22, 2023

(51) Int. Cl. G08B 21/02

(52) U.S. Cl. CPC G08B 21/0266; G08B 21/0277

(57) ABSTRACT

A method to be carried out at an electronic device for detecting proximity to another electronic device is described. The electronic devices are capable of interaction through both low-accuracy sensing and high accuracy sensing. Low-accuracy sensing is used until a potential proximity event is detected. High-accuracy sensing is then activated, and attempts are made using high-accuracy sensing to detect a further potential proximity event corresponding to the potential proximity event. A determination is then made as to whether a proximity event has taken place—this is done using the further potential proximity event if detected, and using the potential proximity event otherwise. A suitable electronic device is also described, as is a method of training electronic devices to detect proximity to other electronic devices using a proximity estimation algorithm.

### TECHNICAL FIELD

The disclosure relates to methods and apparatus for proximity sensing. It is particularly relevant to proximity sensing using electronic devices.

### BACKGROUND

It is important in a number of real-world applications to detect the distance between two individuals or objects. For example, in robotics it may be important to detect distance between objects in order to navigate a path through obstacles. Such a determination may be used in proximity sensing between electronic devices, which has become increasingly important in a range of contexts. In 2020, an important use of this technology has been in determining whether contact tracing is required, as this is widely identified as being necessary when a person has been in close proximity to another person determined as infected with SARS-COV-2. It may also be used to encourage social distancing, for example by providing warnings when social distancing protocols are being breached.

Determination of whether individuals are in close contact is typically made by a contact tracing app, which uses a short-range wireless technology such as Bluetooth Low Energy (Bluetooth LE) to determine whether individuals have been in sufficiently close contact for over a specific length of time. Other personal area network technologies can be used for this purpose, but Bluetooth LE is particularly effective because of its low power consumption in maintaining a broadly consistent communication range.

Use of short-range wireless technologies such as Bluetooth LE can be challenging, however, as there is often very significant variation in performance in wireless networks between different environments. Scheunemann et al, “Utilizing Bluetooth Low Energy to recognize proximity, touch and humans” (25th IEEE International Symposium on Robot and Human Interactive Communication (RO-MAN) Columbia University, New York City, USA, 2016) indicates that at distances over 1 metre, there is little correlation between distance and received signal strength for Bluetooth LE. In contexts where the threshold between “in proximity” and “not in proximity” may be at a distance greater than 1 metre, this limits the practical value of using Bluetooth LE, and similar wireless technologies. There are other technologies that may potentially provide more accuracy than Bluetooth LE—such as infrared ranging and ultra-wideband radio—but these typically have other significant drawbacks, in particular higher power demands that may not be consistent with use for an “always-on” application.

### SUMMARY OF DISCLOSURE

In a first aspect, the disclosure provides a method at an electronic device for detecting proximity to another electronic device, wherein the electronic devices are capable of interaction through low-accuracy sensing and high accuracy sensing, the method comprising: using low-accuracy sensing until a potential proximity event is detected; activating high-accuracy sensing, and attempting to detect a further potential proximity event corresponding to the potential proximity event using high-accuracy sensing; and determining whether a proximity event has taken place using the further potential proximity event if detected, and the potential proximity event otherwise.

Using this approach, the benefits of using a high-accuracy sensing technique can be realised without unacceptable power drain. Use of a low power but low-accuracy sensing technique to determine whether there is a possible proximity event, and then activating the high-accuracy sensing technique just to determine whether the possible proximity event is an actual proximity event, allows the benefits of both approaches to be combined effectively.

In embodiments, the determination whether a potential proximity event is a proximity event from low-accuracy sensing may use a proximity estimation algorithm. Such a proximity estimation algorithm may be optimised by use of machine learning techniques, as is described further below.

Determination of a proximity event may comprise a determination that the electronic device is less than a threshold distance from the other electronic device. The high-accuracy sensing may comprise a measurement of a distance from the electronic device to the other electronic device. This could constitute time-of-flight measurement, for example, and such high-accuracy sensing could comprise one or more of infrared sensing, ultrasonic sensing, and ultrawideband radio sensing.

High-accuracy sensing could be activated according to a predetermined activation plan. This may involve activation of high-accuracy sensing for a predetermined period once a potential proximity event has been detected.

Low-accuracy sensing could simply comprises communication using a short-range radio technology—a suitable choice of short-range radio technology is Bluetooth Low Energy.

A user alert may also be provided if it is determined that a proximity event has taken place. Such a user alert may comprise one or more of a visual alert, an audible alert, and a haptic alert.

In a second aspect, the disclosure provides a method of training electronic devices to detect proximity to other electronic devices using a proximity estimation algorithm according to the method of the first aspect where the determination whether a potential proximity event is a proximity event from low-accuracy sensing uses a proximity estimation algorithm, the method comprising: receiving one or more results of proximity detection according to the method of the first aspect in which both a potential proximity event and a further potential proximity event have been detected; compiling the results into a machine learning data set; using the machine learning data set and a machine learning process to produce an improved proximity estimation algorithm, and providing the improved proximity estimation algorithm for replacement of an existing proximity estimation algorithm.

This method may be performed at a service remotely from the electronic devices, wherein the service receives the one or more results from the electronic devices and provides the improved proximity estimation algorithm to the electronic devices. Alternatively, the method may be performed at an electronic device, wherein the electronic device receives proximity estimation algorithm parameters derived from the one or more results and provides the improved proximity estimation algorithm for replacement of its own proximity estimation algorithm.

In embodiments, the machine learning data set relates to a plurality of electronic devices in a common environment. A single environment may also be divided into sub-environments, for example by use of beacons to label separate sub-environments, and separate data sets may be developed for separate sub-environments. In other embodiments, the machine learning data set may relate to a single electronic device.

In a third aspect, the disclosure provides an electronic device adapted for detecting proximity to another electronic device, the electronic device comprising: a low-accuracy sensing means for determining proximity to another electronic device; and a high-accuracy sensing means for determining proximity to another electronic device; wherein the electronic device is adapted to use low-accuracy sensing until a potential proximity event is detected, activate and use high-accuracy sensing to detect a further potential proximity event corresponding to the potential proximity event, and determine whether a proximity event has taken place using the further potential proximity event if detected, and the potential proximity event otherwise.

In embodiments, the electronic device further comprises a proximity estimation algorithm for determining from low-accuracy sensing whether a potential proximity event is a proximity event.

In embodiments, determination of a proximity event may comprise a determination that the electronic device is less than a threshold distance from the other electronic device, and the high-accuracy sensing means may be adapted to measure a distance from the electronic device to the other electronic device. The high-accuracy sensing means may comprise one or more of infrared sensing, ultrasonic sensing, and ultrawideband radio sensing means.

In embodiments, the electronic device is adapted for activation of high-accuracy sensing for a predetermined period once a potential proximity event has been detected.

The low-accuracy sensing means may comprise a short-range radio technology for communication between electronic devices. This short-range radio technology may for example be Bluetooth Low Energy.

The electronic device may also comprise a user alert means for activation if it is determined that a proximity event has taken place. Such a user alert means may comprise one or more of a visual alert, an audible alert, and a haptic alert.

### BRIEF DESCRIPTION OF FIGURES

Embodiments of the disclosure will now be described, by way of example, with reference to the following figures, in which:

FIG. 1 shows an exemplary proximity sensing environment in which embodiments of the disclosure may be employed;

FIG. 2 illustrates schematically a broad embodiment of the disclosure;

FIGS. 3A and 3B illustrates implementation of an embodiment of a method according to the disclosure in detail;

FIG. 4 illustrates schematically an infrastructure for implementing embodiments of the disclosure; and

FIG. 5 illustrates schematically an electronic device suitable for use in embodiments of the disclosure.

### DETAILED DESCRIPTION

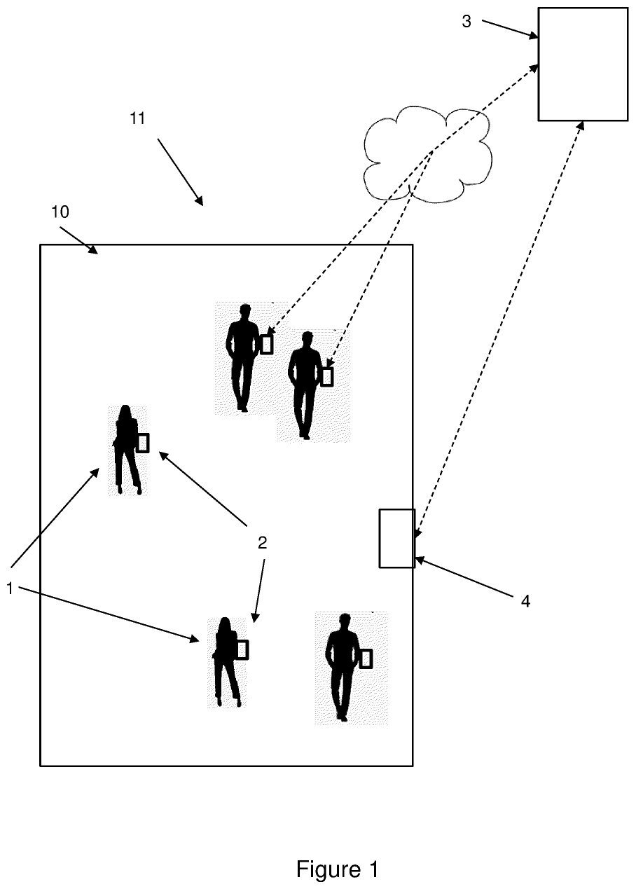

FIG. 1 illustrates an exemplary system 11 for proximity sensing in an environment 10. In this case, the system is one that could be used to support social distancing within a workplace. Users 1 each bear an electronic device 2 adapted for sensing the close presence of other electronic devices through a suitable technology, such as short-range wireless.

These electronic devices 2 are here interacting over appropriate network connections with a cloud service 3 which can provide analysis and reporting over the assemblage of electronic devices 2. This is shown here as reporting back to a site server 4 which provides reporting for a site. Other computing architectures are possible, as is described further below.

In this case, the proximity sensing system 11 is one that could be used to support social distancing within a workplace, for example. For example, each of the plurality of electronic devices 2 may include a wireless communication system for transmitting and receiving communication signals containing identifiers of the respective electronic device 2. The communication signals may, for example, take the form of advertisements and are referred to as such in the following description.

The electronic devices 2 may be devices that are specifically developed for sensing the close presence of other electronic devices 2, or they may be dual purpose devices with another function in the environment (for example, a user's security pass, which also serves to open doors within the environment). They may also be general-purpose computing or communication devices—such as a user's mobile telephone—running a suitable application, and accessing hardware already present in the general-purpose device. Furthermore, for convenient monitoring, each electronic device 2 may for example, take the form of, or be incorporated into, a wearable device, such as an item of personal protection equipment, which may be particularly suited to proximity sensing in a healthcare environment, for example.

When one of the electronic devices moves within range of another one of the electronic devices, each of the first and second electronic devices can detect the respective advertisements transmitted from the other electronic device and thereby identify that electronic device based on the respective device identifier. As will be described further below, the electronic devices are further configured to measure the signal strength of the received advertisements and thereby to determine the proximity of the detected electronic device, for example based on a received signal strength indication (RSSI) of the advertisements.

In this manner, when two or more device-carrying individuals meet, the proximity sensing system 11 is able to determine the proximity of the respective electronic devices 2, and the duration of the contact between the individuals, which can be recorded and used for various advantageous purposes. To minimise the risk of unobserved devices or contact events, each electronic device 2 may be configured to transmit the advertisements periodically, for example at a rate, or frequency, that is optimised for adequate contact detection.

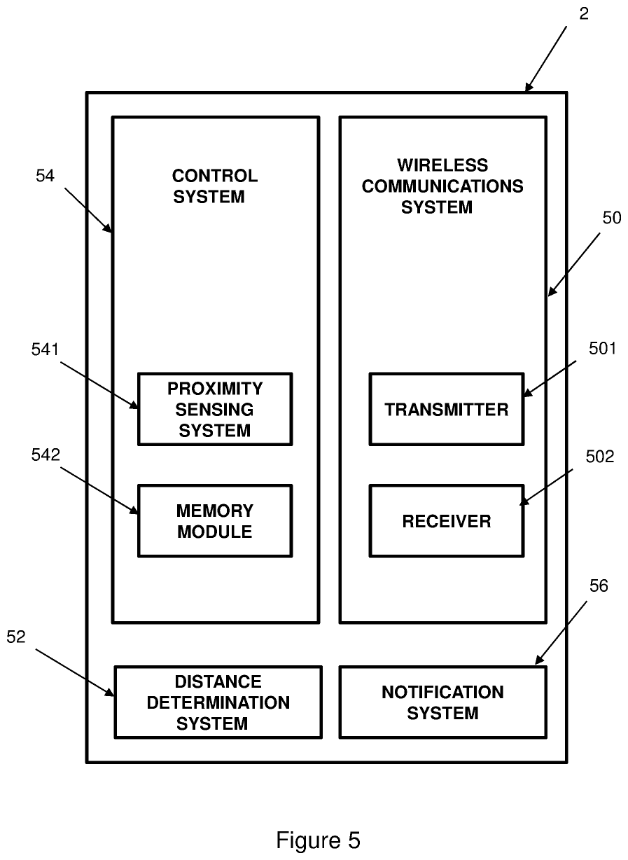

FIG. 5 illustrates a non-limiting example of such an electronic device 2.

As shown in FIG. 5, the electronic device 2 here includes a wireless communication system 50, a distance determination system 52, a control system 54 and a notification system 56.

The wireless communication system 50 may be substantially as described above and is operable by the control system 54 to transmit advertisements for detection by the other electronic devices and to scan for counterpart advertisements transmitted from the other electronic devices. The advertisements may be transmitted on any suitable communication channel, including a Bluetooth® low energy, an Infrared, a WiFi, and/or an Ultrawide band, communication channel. For this purpose, the wireless communication system 50 may include one or more transmitters 501 and one or more receivers 502, such as Bluetooth® Low Energy transmitters and receivers, as shown in FIG. 5.

The wireless communication system 50 can be used, as is described below, to determine proximity between electronic devices. In addition to the wireless communication system 50, there is also provided a distance determination system 52 adapted to provide an accurate determination—essentially a measurement rather than an estimation—of the distance between electronic devices. This can use one or more of a variety of technologies—for example ultrasound or infrared, possibly using time-of-flight techniques, or radio technologies adapted for accurate positional measurement such as ultrawideband (UWB).

The control system 54 is configured to control the wireless communication system 50 for proximity sensing. In particular, the control system 54 is configured to control the scanning for advertisements, performed by the receiver(s) 502 of the wireless communication system 50, and the transmission of advertisements from the transmitter(s) 501 of the wireless communication system 50.

When one or more advertisements are received from another electronic device, the control system 54 is configured to determine the proximity of the detected electronic device. In examples, the control system 54 may be configured to quantify the proximity, for example as an estimate of the distance between the electronic devices, and/or to estimate a binary outcome, such as whether or not a contact event has occurred, by estimating whether the proximity of the detected electronic device is within a proximity threshold (e.g. estimating whether or not a physical distance between the electronic devices is less than a specified distance threshold).

For this purpose, the control system 54 may include a proximity sensing module 541 configured to determine the proximity of the detected electronic device based on the one or more received advertisements. The proximity sensing module 541 may determine the proximity based, at least in part, on a received signal strength indication, RSSI, of the one or more received advertisements, for example. However, noise and interference can have a significant impact on the properties of the received advertisement(s), including the RSSI of such signals. Hence, for accurate proximity sensing, the proximity sensing module 541 is here programmed to execute one or more proximity estimation algorithms or techniques for analysing the RSSI of the received advertisement(s) and determining the proximity of the detected electronic device. The proximity estimation algorithm may be refined by machine learning—for example, by use of a support vector machine, decision tree, random forest, convolutional neural network, long-short term memory network, or another form of artificial neural network. Such a machine-learning developed algorithm may also comprise features such as thresholding, averaging, and/or weighted averaging in order to produce reliable results. The algorithm may further use regression, such as linear regression, for quantifying the proximity of the detected electronic devices (e.g. as a distance in centimetres), and/or logistic regression, for estimating a binary outcome (such as the detection of a contact event, i.e. whether or not the distance between the electronic devices is less than a specified threshold). Use of machine learning to refine a proximity estimation algorithm using the location determination system 52 is described further below.

The control system 54 here includes a memory storage module 542 comprising a contact database for storing records of detected advertisements, and/or electronic devices, including the device identifier, the determined proximity of that electronic device, and a timestamp associated with the detected contact. The memory storage module 542 may interact over appropriate network connections with the cloud service 3 for providing updates, corrections, or additions to the contact database. The wireless communications system 50 may also connect to the site server 4 to provide data consolidation of contact events.

For the purpose of receiving and/or storing such data, the memory storage module 542 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

The notification system 56 is operable by the control system 54 to notify the user when contact with another electronic device is detected. For example, the notification system 56 may be operated upon detecting a contact event. In this manner, the electronic device 2 may be used as to support social distancing when a social distancing area is encroached. The notification system 56 may take various forms for this purpose and may include any suitable device for notifying the user by means of audio, visual, and/or haptic feedback. For example, the notification system 56 may include a display screen and/or a speaker for providing visual and/or audible notification of the detected contact.

For purposes of this disclosure, it is to be understood that the functional systems, elements, and modules of the electronic device 2 described herein may each comprise a control unit or computational device having one or more electronic processors. A set of instructions could be provided which, when executed, cause said control unit(s) to implement the control techniques described herein (including the described method(s)). The set of instructions may be embedded in one or more electronic processors, or alternatively, the set of instructions could be provided as software to be executed by one or more electronic processor(s). The set of instructions may be embedded in a computer-readable storage medium (e.g., a non-transitory computer-readable storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

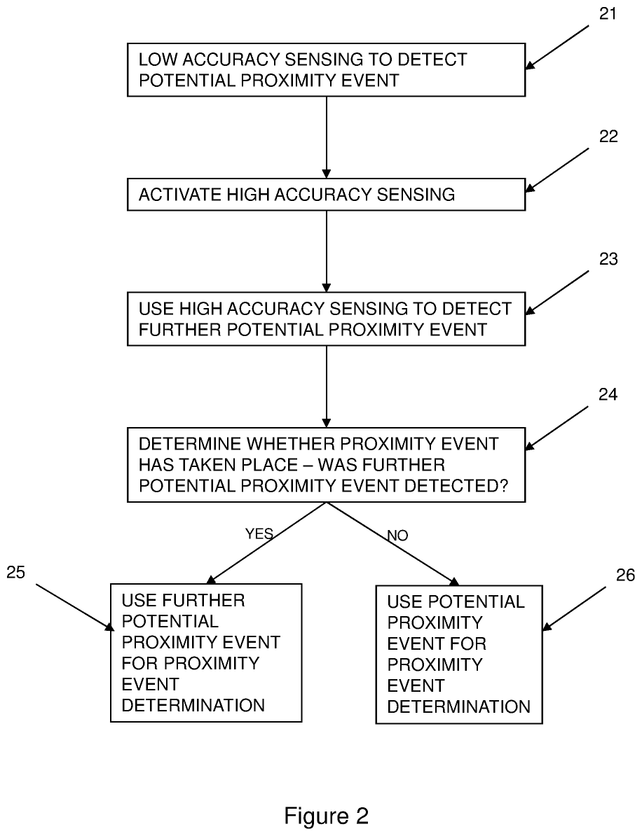

FIG. 2 shows a broad embodiment of a method of the disclosure to enable one electronic device 2 to detect proximity to another electronic device. To perform the method, such an electronic device needs to be equipped with both a low-accuracy sensing mechanism and a high-accuracy sensing mechanism. In the FIG. 5 example, the low-accuracy sensing mechanism is provided by the wireless communications system 50, and the high-accuracy sensing mechanism is provided by the location determination system 52. The low-accuracy sensing mechanism will typically be one that is particularly suitable for always-on use—typically, it will have a low power demand and be very stable. Bluetooth LE is such a technology, though other short-range wireless technologies suitable for personal area networks could also be used. A high-accuracy sensing mechanism will typically have a significantly higher power demand and may not be so suitable for always-on use—exemplary technologies are those used for ranging over short distances—infrared, ultrasound, and possibly also ultra-wideband radio.

First of all, low-accuracy sensing is used 21 until a potential proximity event is detected. This may be carried out as a permanent background activity while the electronic device is on, with sensing events taking place at predetermined intervals, or according to some other predetermined strategy.

When the potential proximity event is detected, the high-accuracy sensing is activated 22. This is then used to attempt to detect 23 a further potential proximity event corresponding to the potential proximity event using the high-accuracy sensing. There may again be a specific strategy used for this detection—it may, for example, operate for a specific window of time after the potential proximity event is detected.

After this, there is a determination 24 as to whether an actual proximity event has taken place. If a further potential proximity event was detected using the high-accuracy sensing, then this is used 25. If no such further potential proximity event was detected, then the earlier potential proximity event is used 26.

As will be further described below, there can be additional benefits from the combined use of high-accuracy and low-accuracy sensing for the same proximity event, such as use of the high-accuracy detection for better calibration of the low-accuracy detection. Because of the complexity of radio environments, such calibration is not a simple adjustment—an effective approach is for machine learning to be used to determine how to use low-accuracy results when only these are available based on the established data sets of low-accuracy and high-accuracy results.

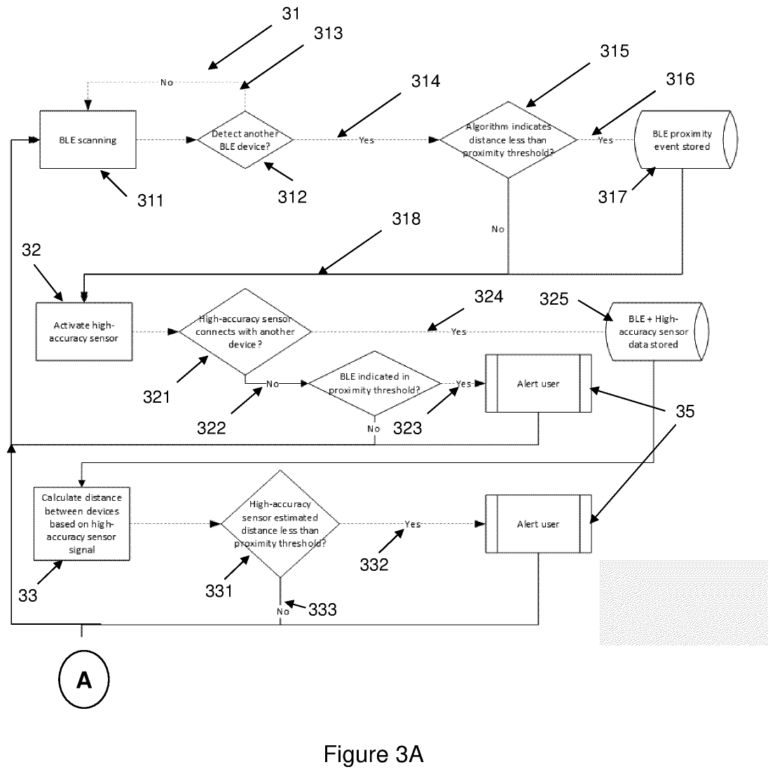

FIGS. 3A and 3B shows an exemplary implementation of such a method in detail.

The method starts with a scanning process using a scanning loop 31—this is based around a Bluetooth Low Energy (BLE) scanning event 311. As indicated above, another signal that is otherwise suitable but lacks desired accuracy may be used instead of Bluetooth Low Energy. Another device may or may not be detected 312 in the scanning event. If there is no other device detected, the loop continues 313 according to a predetermined pattern (this may be simply a predetermined frequency, or there may be a more complex continuation based on environment or user behaviour). If another device is detected 314, the method breaks out of the scanning loop 31.

When the scanning process detects another device, an algorithm is used to analyse 315 the Received Signal Strength. The purpose of this algorithm is to determine whether the distance between the devices is less than a proximity threshold. While the relationship between Received Signal Strength and distance might be estimated as being inversely proportional to some order, this has been found (for example, by Scheunemann et al as discussed above) not to be a reliable estimation. In embodiments described, the algorithm is developed by machine learning from existing data—it may thus be implemented as a machine learning algorithm such as a support vector machine, decision tree, random forest, convolutional neural network, long-short term memory network, or another form of artificial neural network. Such an algorithm may also comprise features such as thresholding, averaging, and/or weighted averaging in order to produce reliable results. The algorithm may further use regression, for example, linear regression to predict a continuous variable (such as distance in centimetres), or logistic regression to estimate a binary outcome (such as whether or not the distance exceeds a specified threshold).

If the algorithm indicates 316 that a proximity event occurred—in other words, that the devices are determined to be within a certain proximity threshold, typically a distance threshold—the event is stored 317. This event here comprises a timestamp, together with a suitable variable to indicate the event occurred (e.g. an integer value of ‘1’ may indicate that a proximity event has occurred). Whether or not the proximity event is stored, it is treated as a potential proximity event and passed 318 to the next stage of the method.

When the Bluetooth Low Energy sensor has detected another device, the high-accuracy sensor is activated 32. The high-accuracy sensor could be infrared or ultrasonic, or another form of high-accuracy sensor, such as ultra-wideband (UWB) wireless.

Both infrared light and ultrasonic sound are widely used for distance measurement over ranges of centimetres to metres—simple time-of-flight is used for distance determination when signals are reflected off a target—this approach can still broadly be used where signals are exchanged between devices, provided that the interaction provides appropriate synchronisation between the devices or accounts accurately for propagation delays. There are a number of other known approaches—for example, synchronous pulses of infrared light and ultrasonic sound can be used together and the difference in arrival time between them measured—and the person skilled in the art will readily determine which solution is most appropriate to the use context.

UWB wireless can also be used for fine ranging. UWB is a technology for transmitting information across a wide bandwidth (>500 MHZ). UWB was formerly known as pulse radio, but it is now defined by the FCC and the International Telecommunication Union Radiocommunication Sector (ITU-R) as an antenna transmission for which emitted signal bandwidth exceeds the lesser of 500 MHz or 20% of the arithmetic centre frequency (which will typically include former pulse radio implementations but is not limited to them). This approach will typically allow a significant transmission energy as the amount of energy in any reserved signal band is low.

The high-accuracy sensor will now seek 321 to connect with the other device that has already been detected using the low-accuracy sensor. The high-accuracy sensor may or may not succeed in detecting this other device. There may be a number of possible reasons for this, but a frequent one is that many high-accuracy sensing technologies have a more limited or more asymmetric field of view than Bluetooth LE—for example, some infra-red sensing systems are known to have a field of view of approximately 27 degrees, whereas Bluetooth LE will provide some degree of performance at all angles. Physical obstructions may also be more problematic for some technologies (for example, infra-red) than for short-range wireless. Some devices may therefore be detected by Bluetooth LE but not by the high-accuracy sensor. For these devices that are not detected 322 by the high-accuracy sensor, the determination of proximity threshold made by Bluetooth LE stands. Consequently, if Bluetooth LE did detect that the interaction was within the proximity threshold 323, then that is taken as determinative and a user alert 35 is made. This may be by any appropriate means, such as by an LED or by haptic feedback. The system then reverts to the initial loop.

However, if the high-accuracy sensor does also successfully detect 324 another device, both the low-accuracy and the high-accuracy sensor readings are stored 325. As will be seen below, these can be used subsequently for training the initial proximity threshold analysis algorithm. If there has been both low-accuracy and high-accuracy detection, the method then moves to the next stage. Care may need to be taken that the low-accuracy detection and the high-accuracy detection relate to the same device—this may be done, for example, by having a device identifier embedded in the signals used.

In this next stage, the distance between the two devices is calculated 33 using the high-accuracy sensor. This may be done according to received signal strength (for example, for a wireless technology such as UWB) or according to a time-of-flight based approach (for example, for infra-red or ultrasound). This enables an accurate determination 331 of whether or not the devices are within the proximity threshold. If they are 332, then a user alert 35 is made as before, whereas if they are not 333, then no alert is made. In either case, the method continues to the next stage, although at this point it can also restart scanning and so reverts to the start of the process.

In this next stage, shown in FIG. 3B, the new information from the detection event is used to improve 34 the initial proximity threshold analysis algorithm by training. Every event in which there is data from both the low-accuracy sensor and the high-accuracy sensor adds 341 a new value to a data set of such values that can be used in a machine learning process. This data set may relate to a single device, or it may cover an assemblage of similar devices all operating in the same environment. The purpose of this process is to refine the responses achieved from low-accuracy sensor values alone so that they will correspond better to the results achieved using high-accuracy sensors, which are taken as being “true values” for distance between devices. This dataset may then be used according to conventional machine learning approaches to retrain 342 the model—any appropriate machine learning model appropriate to the data and to the metric for evaluation of the data may in principle be used. This retraining may be done at any time after new data is added—it may for example be done after a predetermined number of new values have been added to the dataset, but it could even be done after every new value is added to the dataset. In line with normal machine learning approaches, the retrained algorithm is tested 343 on a subset of the sensor data that was withheld from the training process to determine 344 whether or not the retrained algorithm performs better according to an evaluation metric. This evaluation metric can be accuracy of determination whether or not the proximity threshold has been breached, or another evaluation metric relevant to machine learning, such as precision or recall (https://en.wikipedia.org/wiki/Precision_and_recall). If the revised model is better, it can replace 345 the current version of the algorithm in the user device—if it is not, then the evaluation process simply stops. Scanning should restart at this point if it has not already restarted after the end of the detection process shown in FIG. 3A.

In this way, the algorithm may be tailored from original factory settings to correspond to the situation in a specific environment. There may for example be some tailoring to room-level radio propagation characteristics of the environment which will affect the relationship between signal strength and distance—for example, a space with a significant number of metal objects such as computers or machinery may have different signal propagation characteristics to a largely empty corridor. The main environment could for be divided into sub-environments—for example, by providing beacons throughout the environment which could also be detected at the time of detecting a proximity event—and different data sets could be provided for the different sub-environments, resulting in different machine learning models, and hence different tuning of the proximity estimation algorithm, for different sub-environments. In proximity detection, an initial step of the scanning process would then be to determine whether a beacon was detected, with this determining the version of the proximity estimation algorithm to be used.

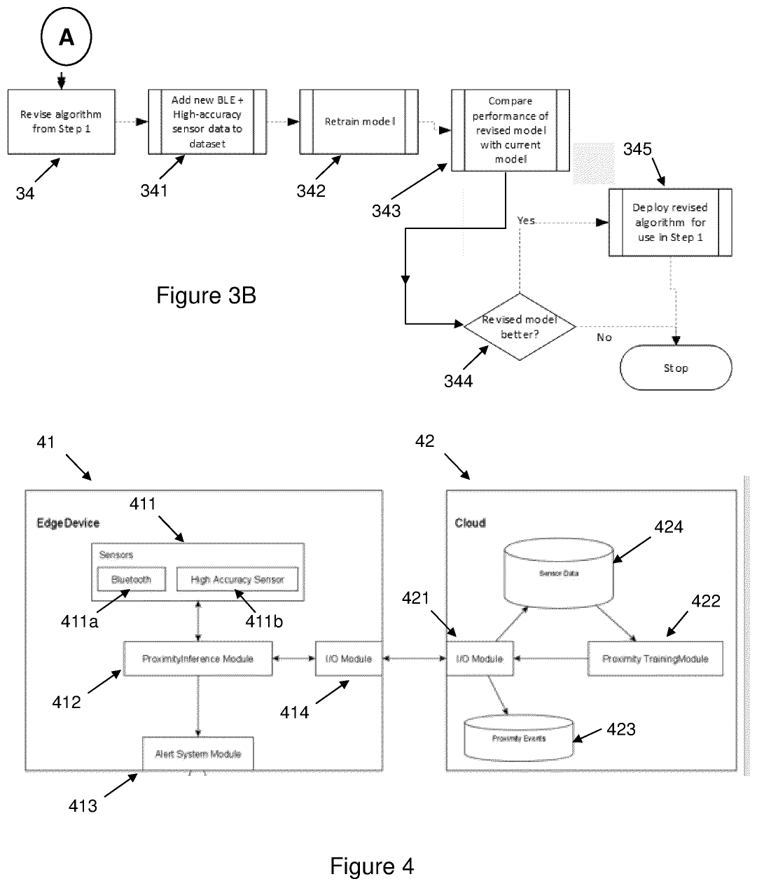

A system architecture for implementing this approach in a proximity detection system for use in a particular environment is shown in FIG. 4. This architecture is based around two types of device—an edge device 41 and a cloud system (or a remote server) 42. In practice, there will be a number, possibly a large number of edge devices 41. These devices may all be interacting within a specific environment, such as a building or set of buildings, as shown in FIG. 1.

The term “edge device” is widely used in the domain of Internet of Things (IOT) and cloud computing. Most generally, an edge device is any piece of hardware that controls data flow at the boundary between two networks, or otherwise operates at the periphery of a system. Here, it may be implemented by specialised hardware used simply for proximity detection (for example, for contact tracing), by multipurpose hardware such as enhanced security badges, or by general-purpose hardware such as a user mobile telephone or tablet. Edge devices fulfil a variety of roles, depending on what type of device they are, but they essentially serve as network entry—or exit—points, and they typically are involved in the transmission, routing, processing, monitoring, filtering, translation and storage of data passing. Edge devices are widely used in IoT contexts as these increasingly require more intelligence, computing power and advanced services to be deployed at the network edge. Such decentralisation of processes to a more logical physical location is referred to as edge computing.

Here, the edge device 41 is equipped to perform proximity detection according to the method described. It possesses relevant sensors 411, specifically here a Bluetooth LE sensor 411a and a high-accuracy sensor 411b. These sensors are accessed by the proximity inference module 412, which determines from the sensor readings whether a proximity threshold has been breached. If the proximity threshold has been breached, the proximity inference module 412 triggers an alert which is communicated to the user by an alert system module 413. The alert system module 413 triggers messages to the user in cases of close proximity to enable corrective actions if necessary.

The edge device 41 also has an interface module 414 which provides an interface to the cloud service 42. The cloud service receives data from the edge device 41 through its own interface module 421 and collects two data sets received from the edge devices 41, indicated here as separate databases: proximity events 423 and sensor data 424. Devices may access the cloud directly (e.g., by having mobile or WiFi connectivity) or can send data to a forwarder device that forwards data between the devices and the cloud. In the latter case, the data of many devices can be assembled and sent as one message to the cloud.

The record of proximity events 423 is used for analytical purposes typically related to the purpose for which proximity is detected—for example, to determine when contact tracing is required after it is found that a user of the system has contracted an infectious disease, and it is desired to determine who has been in close proximity to the user for a sufficient period of time. These analysis results may be fed back to the edge device 41 through the interface modules 414, 421 to provide information to the user—for example, that there has been a significant contact tracing event which requires user attention.

The sensor data 424, however, is not typically used for further analytical purposes, but rather for improvement of the proximity inference module 412 in the edge device 41. As indicated previously, this may be for individual devices, or may be for an assemblage of similar devices operating in a common environment. Sensor readings such as RSS data are stored for events that are detected as both low-accuracy detected and high-accuracy detected proximity events. The algorithm used in the proximity inference module 412 can then be both retrained and tested in the cloud by a proximity training module 422. If the test algorithm in the cloud performs better than the version currently on the edge device 41, the revised algorithm can replace the algorithm currently used in the proximity inference module 412 at an appropriate time. Typically, this will involve only a change of weights rather than a fundamental change to the algorithm architecture, but this is also a possibility (for example if a different type of machine learning algorithm starts to perform more effectively than the type currently used as more data is developed).

While training in the cloud is a particularly effective option, it is not the only possibility. For example, retraining of the algorithm may take place at the edge device without any data leaving it, for example by using federated learning methods operating across a community of edge devices. Using such approaches, the edge devices may share the same machine learning model (for example, a deep neural network) and periodically exchange parameters (such as weights and biases of the deep neural network), rather than actual data, with other edge devices so that edge devices will take advantage of learning elsewhere and so progress towards a common solution (this is described in more detail, for example, at https://en.wikipedia.org/wiki/Federated learning).

The skilled person will appreciate that many further embodiments are possible within the spirit and scope of the disclosure set out here.

1. A method at an electronic device for detecting proximity to another electronic device, wherein the electronic devices are capable of interaction through low-accuracy sensing and high accuracy sensing, the method comprising:
using low-accuracy sensing until a potential proximity event is detected;
activating high-accuracy sensing, and attempting to detect a further potential proximity event corresponding to the potential proximity event using high-accuracy sensing; and
determining whether a proximity event has taken place using the further potential proximity event if detected, and the potential proximity event otherwise.

2. The method of claim 1, comprising determining whether a potential proximity event is a proximity event from low-accuracy sensing using a proximity estimation algorithm.

3. The method of claim 1, wherein determination of a proximity event comprises a determination that the electronic device is less than a threshold distance from the other electronic device.

4. The method of claim 3, wherein high-accuracy sensing comprises a measurement of a distance from the electronic device to the other electronic device.

5. The method of claim 4, wherein high-accuracy sensing comprises time-of-flight measurement.

6. (canceled)

7. The method of claim 1, further comprising only activating high-accuracy sensing according to a predetermined activation plan.

8. The method of claim 7, wherein the predetermined activation plan comprises activation of high-accuracy sensing for a predetermined period once a potential proximity event has been detected.

9. The method of claim 1, wherein low-accuracy sensing comprises communication using a short-range radio technology.

10. (canceled)

11. The method of claim 1, further comprising providing a user alert if it is determined that a proximity event has taken place.

12. (canceled)

13. A method of training electronic devices to detect proximity to other electronic devices using a proximity estimation algorithm according to the method of claim 2, the method comprising:
receiving one or more results of proximity detection in which both a potential proximity event and a further potential proximity event have been detected;
compiling the results into a machine learning data set;
using the machine learning data set and a machine learning process to produce an improved proximity estimation algorithm, and
providing the improved proximity estimation algorithm for replacement of an existing proximity estimation algorithm.

14. The method of claim 13, wherein the method is performed at a service remotely from the electronic devices, wherein the service receives the one or more results from the electronic devices and provides the improved proximity estimation algorithm to the electronic devices.

15. The method of claim 13, wherein the method is performed at an electronic device, wherein the electronic device receives proximity estimation algorithm parameters derived from the one or more results and provides the improved proximity estimation algorithm for replacement of its own proximity estimation algorithm.

16. The method of claim 13, wherein the machine learning data set relates to a plurality of electronic devices in a common environment.

17. An electronic device adapted for detecting proximity to another electronic device, the electronic device comprising:
a low-accuracy sensing means for determining proximity to another electronic device; and
a high-accuracy sensing means for determining proximity to another electronic device;
wherein the electronic device is adapted to use low-accuracy sensing until a potential proximity event is detected, activate and use high-accuracy sensing to detect a further potential proximity event corresponding to the potential proximity event, and determine whether a proximity event has taken place using the further potential proximity event if detected, and the potential proximity event otherwise.

18. The electronic device of claim 17, further comprising a proximity estimation algorithm for determining from low-accuracy sensing whether a potential proximity event is a proximity event.

19. The electronic device of claim 17 wherein determination of a proximity event comprises a determination that the electronic device is less than a threshold distance from the other electronic device, and wherein the high-accuracy sensing means is adapted to measure a distance from the electronic device to the other electronic device.

20. (canceled)

21. The electronic device of claim 17, wherein the electronic device is adapted for activation of high-accuracy sensing for a predetermined period once a potential proximity event has been detected.

22. The electronic device of claim 17, wherein the low-accuracy sensing means comprises a short-range radio technology for communication between electronic devices.

23. (canceled)

24. The electronic device of claim 17, further comprising a user alert means for activation if it is determined that a proximity event has taken place.

25. The electronic device of claim 19, wherein the user alert means comprises one or more of a visual alert, an audible alert, and a haptic alert.
